(19) United States
(12) Patent Application Publication
(10) Pub. No.: US 2019/0322381 A1
(43) Pub. Date: Oct. 24, 2019

(54) MULTI-ROTOR UNMANNED AERIAL VEHICLE, POWER SYSTEM, ELECTRONIC SPEED CONTROL, AND CONTROL METHOD AND SYSTEM THEREOF

(71) Applicant: SZ DJI TECHNOLOGY CO., LTD., Shenzhen (CN)

(72) Inventors: Wanqi LIU, Shenzhen (CN); Changxing ZHOU, Shenzhen (CN); Qiu LAN, Shenzhen (CN)

(21) Appl. No.: 16/456,945

(22) Filed: Jun. 28, 2019

Related U.S. Application Data
(63) Continuation of application No. PCT/CN2016/112573, filed on Dec. 28, 2016.

(51) Int. Cl. B64D 31/06; B64D 27/24; B64C 39/02

(52) U.S. Cl. CPC B64D 31/06; H04L 5/0005; B64C 39/024; B64D 27/24

(57) ABSTRACT

A multi-rotor UAV includes a frame and a plurality of propulsion systems configured on the frame. Each propulsion system includes a motor and an electronic speed control (ESC) device. The ESC device of each propulsion system includes: a first communication interface; and a processor configured to acquire voltage information at the first communication interface and determine address information of the ESC according to the voltage information. The multi-rotor UAV further includes a controller connected to the first communication interface of the ESC device of each propulsion system. The controller is configured to send a throttle signal to the ESC device of each propulsion system.

### CROSS-REFERENCE TO RELATED APPLICATION

This application is a continuation application of International Application No. PCT/CN2016/112573, filed on Dec. 28, 2016, the entire contents of which are incorporated herein by reference.

### TECHNICAL FIELD

The present disclosure relates to the technical field of aerial vehicles and, in particular, to an unmanned aerial vehicle, a propulsion system, an electronic speed control (ESC) and the system and control method thereof.

### BACKGROUND

With the rapid development of science and technology, unmanned aerial vehicle (UAV) technology has become more mature. Multi-rotor UAV is currently the most common type of UAVs. In general, multi-rotor UAVs have two or more rotors. Each rotor of a multi-rotor UAV may be controlled through an electronic speed control (ESC). In order for each ESC to accurately respond to control signals from the flight controller, the multiple ESCs need to be distinguished and numbered. That is, a unique address needs to be assigned to each ESC.

Currently, in the process of distinguishing and numbering a plurality of ESCs, each ESC is assigned a unique address by storing a different program to the ESC. For example, four different programs may be stored to the four ESCs of a quad-rotor UAV to define the four ESCs as the No. 1, No. 2, No. 3 and No. 4 ESCs. However, the ESCs numbered with the above process of storing different programs to the ESCs may require apparent location distinctions. That is, an ESC assigned with a particular number is required to be installed in a corresponding location in the multi-rotor UAV. An incorrect installation location may cause difficulties in a multi-rotor UAV's takeoff, or an explosion after the takeoff. Thus, when an ESC is to be installed or repaired, it is necessary to first determine the numbering and corresponding installation location of the ESC, thereby causing inconvenience in installation or maintenance.

### SUMMARY

In order to overcome some of the drawbacks in existing UAVs including inconvenience in ESC installation and maintenance, the present disclosure provides an unmanned aerial vehicle, a propulsion system, an electronic speed control (ESC) and the system and control method thereof. Accordingly, the technical solutions to solve the technical problem of the present disclosure include the followings.

In one aspect of the present disclosure, a multi-rotor unmanned aerial vehicle (UAV) is provided. The multi-rotor UAV includes a frame and a plurality of propulsion systems configured on the frame. Each propulsion system includes a motor and an electronic speed control (ESC) device. The ESC device of each propulsion system includes: a first communication interface; and a processor configured to acquire voltage information at the first communication interface and determine address information of the ESC according to the voltage information. The multi-rotor UAV further includes a controller connected to the first communication interface of the ESC device of each propulsion system. The controller is configured to send a throttle signal to the ESC device of each propulsion system.

### BRIEF DESCRIPTION OF THE DRAWINGS

In order to more clearly illustrate the technical solutions in the embodiments of the present disclosure, the drawings used in the description of the embodiments are briefly described below. It is obvious that the drawings in the description are only some embodiments of the present disclosure. Other drawings can also be derived by those of ordinary skill in the art based on the disclosed drawings without creative efforts.

FIG. 1 illustrates a method for controlling an ESC according to certain embodiments of the present disclosure;

FIG. 2 illustrates a process for determining address information according to voltage information according to certain embodiments of the present disclosure;

FIG. 3 illustrates an ESC control system connected to a controller according to certain embodiments of the present disclosure;

FIG. 4 illustrates another ESC control system connected to a controller according to certain embodiments of the present disclosure; and

FIG. 5 illustrates a multi-rotor UAV according to certain embodiments of the present disclosure.

### DETAILED DESCRIPTION

The technical solutions provided by the present disclosure will be described in conjunction with the drawings in the embodiments of the present disclosure. The described embodiments are only some embodiments of the present disclosure. Other embodiments derived by a person of ordinary skill in the art based on the described embodiments of the present disclosure without creative efforts are within the scope of the present disclosure.

In the present disclosure, the terms of “installed”, “connected”, “fixed”, and so on, should be understood in a general sense. For example, “connection” may be a fixed connection, a detachable connection, or an integral connection. For those skilled in the art, the specific meanings of the above terms in the present disclosure may be understood on a case-by-case basis.

In the description, the terms “first” and “second” are used merely to describe different components, and are not to be construed as indicating or implying a sequential relationship, relative importance or an implicit indication of a quantity. Thus, features defined with “first” and “second” may include at least one of the features, either explicitly or implicitly.

Unless otherwise defined, all technical and scientific terms used herein have the same meaning as commonly understood by one of ordinary skill in the art to which this present disclosure belongs. The terminologies used in the present disclosure are for the purpose of describing particular embodiments and are not intended to limit the present disclosure.

Some embodiments of the present disclosure are described in detail below with reference to the accompanying drawings. In the case where there is no conflict between the embodiments, the features of the following embodiments and examples may be combined with each other.

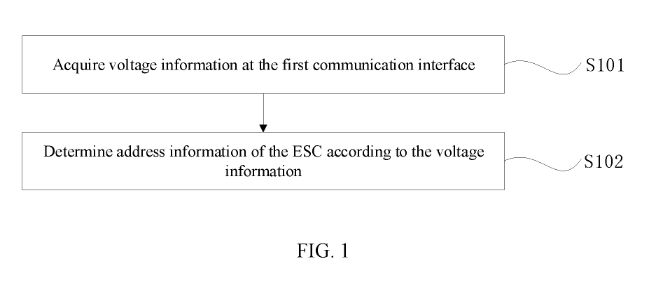

FIG. 1 a flowchart of a control method for an ESC according to certain embodiments of the present disclosure. As shown in FIG. 1, in certain embodiments, a control method is provided for an ESC configured with a first communication interface for a single channel communication. The method may include the following steps.

Step S101 is to acquire voltage information at the first communication interface. The voltage information at the first communication interface may be directly acquired by a processor in the ESC, or may be detected by a voltage measurement device. For example, the voltage information at the first communication interface may be read through an AD pin (data address pin) of the processor or a voltage measurement device electrically connected to the first communication interface. The AD pin or the voltage measurement device may also be an electronic component external to the processor. Further, the specific content of the voltage information is not limited in the present disclosure. The content of the voltage information may be configured according to specific design requirements. For example, the voltage information may include at least one of: a voltage value, a voltage level, and a connection sequence of voltages.

Step S102 is to determine address information of the ESC according to the voltage information. After acquiring the voltage information, the address information of the ESC may be determined according to the voltage information. Then, the determined address information may be used to assign an address the ESC. Specifically, when the acquired voltage information includes the voltage level, the address information of the ESC may be determined according to the voltage level and a preset mapping relationship between voltage levels and address information, so that the determined address information may be used to assign an address to the ESC. Other methods may be used to determine the address information of the ESC according to the voltage information, and the details are not described herein.

Thus, by acquiring voltage information at the first communication interface, and based on the address information of the ESC according to the voltage information, an address may be assigned to the ESC according to the address information. In this approach, the need for individually programming each ESC to assign its address may be eliminated. Instead, a UAV may automatically recognize and assign addresses to all the installed ESCs, thus simplifying the ESC manufacture process. Further, on a multi-rotor UAV, any ESC may be installed in any installation position, eliminating the problem of an ESC not capable of responding accurately. This may greatly reduce the complexity of the assembly process or maintenance process of the UAV, improve the efficiency of assembly or maintenance, thereby saving costs. It may also avoid the safety hazard caused by incorrect installation of the ESC, thereby improving practicality and market adoption of the control method.

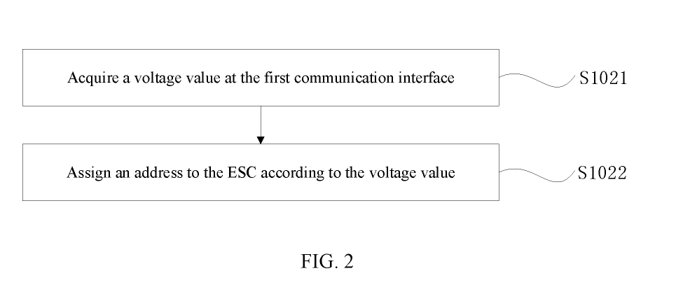

FIG. 2 is a flow chart illustrating the process of determining the voltage ESC address information according to certain embodiments of the present disclosure. Based on the foregoing embodiments, referring FIGS. 1 and 2, the specific implementation process for determining the address assignment information of the ESC based on the voltage information is not limited in the present disclosure. The implementation may be configured according to specific design requirements. Further, determining the address information of the ESC according to the voltage information may include the following steps.

Step S1021 is to acquire a voltage value at the first communication interface. The voltage value may represent the voltage information sufficiently and intuitively. The method of acquiring the voltage value is also simple to implement. For example, the voltage value may be directly acquired through a voltage measurement device or directly from a data address pin. Thus, the convenience of the control method is improved while ensuring the reliability of determining the address information.

Step S1022 is to assign an address to the ESC according to the voltage value. After the voltage value at the first communication interface is acquired, the address information may be determined according to the voltage value, so that the address information may be used to assign an address to the ESC. Specifically, when the voltage value at the first communication interface is acquired, the address information corresponding to the voltage value may be determined according to a mapping relationship between voltage values and address information. The determined address information may be configured as the unique communication address of the ESC, so that the ESC may accurately respond to a controller. Alternatively, the voltage values acquired at the first communication interfaces of a plurality of ESCs may be sorted, and the communication addresses corresponding to the ESCs may be respectively assigned according to a sorting order from the maximum to the minimum, or from the minimum to the maximum. Thus, the ESCs are assigned with corresponding addresses and thereby improving the utility of the control method.

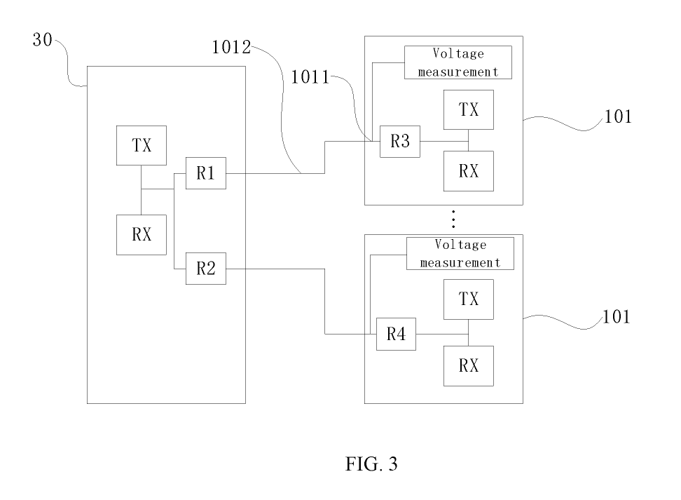

FIG. 3 is a diagram illustrating a configuration of an ESC control system connected to a controller 30 according to certain embodiments of the present disclosure. To ensure the reliability for determining the address information of the ESC according to the voltage information, the first communication interface may be configured to connect a first voltage-dividing component in series.

The specific shape and structure of the first voltage-dividing component are not limited in the present disclosure. These parameters may be configured according to specific design requirements. For example, the first voltage-dividing component may be configured as a resistor or other electronic elements having a voltage-dividing functionality. Further, the first voltage-dividing component can also be configured as other electronic components that consume electrical energy, such as LED lights.

Further, as shown in FIG. 3, the first communication interface of the ESC may be used for communication connection with a second communication interface of the controller 30. The controller may be configured with a second voltage-dividing component connected in series with the second communication interface.

In certain embodiments, there may be multiple second voltage-dividing components. The specific shape and structure of the second voltage-dividing component are not limited. They may be configured according to specific design requirements. Further, the second voltage-dividing components may be resistors, and the multiple second voltage-dividing components in the controller may be resistors having different resistances. Each of the second voltage-dividing components may be respectively connected to the first communication interface of a different ESC. It may be understood that the first voltage-dividing component and the second voltage-dividing component may also be different electronic components. Further, the first voltage-dividing component and the second voltage-dividing component may be configured as resistors to optimize the circuit and to save cost.

Further, the specific implementation manner of the communication connection between the first communication interface and the second communication interface is not limited in the present disclosure. Further, the first communication interface may be configured to communicate using frequency division multiplexing or time division multiplexing to ensure the reliability of data communication between the first communication interface and the second communication interface.

Further, to assign a unique communication address to each of a plurality of ESCs of a multi-rotor UAV, after voltage division by the first and the second voltage-dividing components, the voltage at a single communication line electrically connected between each ESC and the controller needs to be a different voltage value at the first communication interface. For example, for a multi-rotor UAV using resistors as the first voltage-dividing component and the second voltage-dividing component, the second voltage-dividing components of two single communication lines between two ESCs and the controller may be configured as two resistors R1, R2 having different resistances, and the first voltage-dividing components may be configured as two resistors R3, R4 having a same resistance. The specific number of the ESCs may be configured according to the model of the multi-rotor UAV. Thus, at each of the first communication interface, the voltage may be:

$$Ux = \frac{Rx}{Rx + R 4} \times U \qquad ( Eq . 1 )$$

In the above Equation 1, since R3 and R4 have the same resistance, they may be represented by R4. The subscript x is 1 or 2. Ux represents the voltage at the first communication interface. U is the differential voltage across the two ends of first communication interface. Based on the above formula, since a second voltage-dividing component with a unique resistance value is configured in the circuit branch connecting each ESC to the controller, the voltage value at the first communication interface corresponding to each ESC is unique.

After acquiring different voltage values at the first communication interfaces, the following method may be used for assigning addresses. One address assignment approach is to measure the voltage at each first communication interface, search the mapping table of voltage-communication address according to the voltage collected at the each first communication interface to find the corresponding communication address, and to configure the corresponding communication address as the unique communication address for the corresponding ESC.

Another address assignment approach is to measure the voltage at each first communication interface, and then sort the measured voltages from the multiple first communication interfaces from a minimum value to a maximum value to correspond each voltage value to a unique communication address. The communication address corresponding to a specific measured voltage is then configured as the unique communication address of the corresponding ESC. It should be appreciated that the measured voltages from the multiple first communication interfaces and the communication addresses may also be sorted in a sequence from maximum to minimum values. The working principle of the ESC address assignment method of the multi-rotor UAV of certain embodiments is briefly described below.

When the multi-rotor UAV is turned on, the controller and the ESC provide a high voltage level and a low voltage level respectively at the two ends of a single communication line. For example, the controller may connect to one end of a single communication line and set the end to a GND voltage level, while the ESC may connect to the other end of the single communication line and set that end to a high voltage level. Thus, a voltage at the first communication interface between the first voltage-dividing component and the second voltage-dividing component may be measured. Specifically, the voltage at the first communication interface may be collected through an AD pin of the ESC. Next, the ESC processor may compare the voltage collected at the first communication interface to a preset voltage, and assign an address to the ESC according to the comparison result. For example, when a 1V voltage was collected, if searching the preset voltage-communication address mapping table finds a communication address of 1 corresponding to the 1V voltage, then the unique communication address is configured to 1 for the ESC corresponding to the first communication interface having the corresponding voltage 1V. In another example, if the multi-rotor UAV is a quad-rotor UAV, the controller is connected with four ESCs. When the collected voltages of the four first communication interfaces are 1v, 1.2v, 1.1v, and 1.3v, respectively, the four ESCs may be assigned with addresses of 0, 2, 1, and 3, respectively, in the order of voltages sorted from minimum to maximum.

The control method of the ESC provided by the present disclosure may directly assign address to the ESC according to a voltage collected at the first communication interface, thereby simplifying the assembly process, saving assembly time and avoiding security risks caused by incorrect installation. The address assignment method may be the same during maintenance of the multi-rotor UAV ESC. That is, when the ESC is installed during maintenance, the ESC may be installed in any ESC installation position on the frame without considering the correspondence between the location and the ESC communication address. This approach may significantly improve the efficiency of ESC maintenance, save costs, and avoid the safety hazard caused by an incorrect installation position of the ESC.

Further referencing to FIG. 3, according to certain embodiments, the present disclosure provides an ESC control system. Each ESC 101 is provided with a first communication interface 1011 for a single-channel communication. The control system includes one or more processors that operate separately or collectively. The processors are configured to perform: Acquiring voltage information at the first communication interface 1011; and determining address information of the ESC 101 according to the voltage information.

In certain embodiments, the one or more processors include but are not limited to a microprocessor, a reduced instruction set computer (RISC), an application specific integrated circuit (ASIC), an application-specific instruction-set processor (ASIP), a central processing unit (CPU), a physical processing PPU), a digital signal processor (DSP), a field programmable gate array (FPGA).

The process and effect of the specific implementation steps performed by the processor may be the same as the specific implementation process and the effect of Steps S101-S102 in the foregoing embodiments. The details may be found in the description of those embodiments, and are not repeated.

According certain embodiments, the control system of the ESC may acquire the voltage information at the first communication interface 1011 by using a processor, and determine the address information of the ESC 101 according to the voltage information, so that the address information of the ESC 101 may be used to assign an address to the ESC 101. Thus, the need for individually programming each ESC 101 to assign an address may be eliminated. Instead, a UAV may automatically recognize and assign addresses to all the installed ESCs, thus simplifying the ESC manufacture process. Further, on a multi-rotor UAV, an ESC 101 may be installed in any installation position, eliminating the problem of an ESC 101 not capable of responding accurately to the controller 30. This may greatly reduce the complexity of the assembly process or maintenance process of the UAV, improve the efficiency of assembly or maintenance, thereby saving costs. It may also avoid the safety hazard caused by incorrect installation position of the ESC, thereby improving practicality and market adoption of the control system.

Further, with continued reference to FIG. 3, the specific implementation process for determining the address information of the ESC 101 according to the voltage information is not limited in the present disclosure. They may be configured according to specific design requirements. Further, the processor is configured to perform: acquiring a voltage value at the first communication interface 1011; and assigning an address to the ESC 101 according to the voltage value.

Further, the process and result of the specific implementation steps performed by the processor may be the same as the specific implementation process and the effect of Steps S1021-S1022 in the foregoing embodiments. The details may be found in the description of those embodiments, and are not repeated.

In addition, with continued reference to FIG. 3, in order to ensure the reliability of determining the address information of the ESC 101 according to the voltage information, the first communication interface 1011 may be configured with a first voltage-dividing component connected in series. The specific shape and structure of the first voltage-dividing component are not limited in the embodiments. These parameters may be configured according to specific design requirements. For example, the first voltage-dividing component may be configured as a resistor or other electronic elements having voltage-dividing functionality. Further, the first voltage-dividing component can also be configured as other electronic components that consume electrical energy, such as LED lights.

Further, the first communication interface 1011 may be configured to connect to the second communication interface of the controller 30. The controller 30 may be equipped with a second voltage-dividing component in series with the second communication interface.

There may be multiple second voltage-dividing components in certain embodiments. The specific shape and structure of the second voltage-dividing component are not limited. They may be configured according to specific design requirements. Further, the second voltage-dividing components may be resistors, and the multiple second voltage-dividing components in the controller may be resistors having different resistances. Each of the second voltage-dividing components may be respectively connected to the first communication interface 1011 of a different ESC 101. It may be understood that the first voltage-dividing component and the second voltage-dividing component may also be different electronic components. Further, the first voltage-dividing component and the second voltage-dividing component may be configured as resistors to optimize the circuit and save cost.

Further, the specific implementation manner of the communication connection between the first communication interface 1011 and the second communication interface is not limited in the embodiments. Further, the first communication interface 1011 may be configured to communicate using frequency division multiplexing or time division multiplexing ensure the reliability of data communication between the first communication interface 1011 and the second communication interface.

Further, it should be noted that the specific working principle of the control system of the ESC 101 in certain embodiments may be the same as the specific working principle of the control method of the ESC 101 in any of the foregoing embodiments. The details may be found in the foregoing description, and are not described here again.

According to certain embodiments, the control system of the ESC 101 may directly assign an address to the ESC 101 according to a voltage collected by the processor at the first communication interface 1011, thereby simplifying the assembly process, saving assembly time and avoiding security risks caused by incorrect installation of the ESC 101. The address assignment method may be the same during maintenance of the multi-rotor UAV ESC 101, that is, when the ESC 101 is installed during maintenance, the ESC 101 may be installed in any ESC installation position on the frame without considering the correspondence between the location and the ESC 101 communication address. This approach may significantly improve the efficiency of ESC maintenance, saves costs, and avoid the safety hazard caused by an incorrect installation position of the ESC.

According to certain embodiments, an ESC is provided. The ESC is configured to adjust a rotation speed of a motor according to a control signal. Further, a unique communication address may be assigned to each ESC of a multi-rotor UAV by means of hardware detection. Thus, each ESC of the multi-rotor UAV may accurately respond to the controller. Specifically, the ESC may include: A circuit board; and a control system mounted on the circuit board. The control system may be any one of the above-described systems in the foregoing embodiments.

The structure, working principle, and effect of the control system of the ESC in the embodiment may be the same as the control system in the foregoing embodiments. The details may be found in the description of those embodiments, and are not repeated.

According to certain embodiments, the ESC may directly assign an address to the ESC by a processor in the control system according to a voltage collected at the first communication interface, thereby simplifying the assembly process, saving assembly time and avoiding security risks caused by incorrect installation. The address assignment method may be the same during maintenance of the multi-rotor UAV ESC, that is, when the ESC is installed during maintenance, the ESC may be installed in any ESC installation position on the frame without considering the correspondence between the location and the ESC communication address. This approach may significantly improve the efficiency of ESC maintenance, saves costs, and avoid the safety hazard caused by an incorrect installation position of the ESC.

According to certain embodiments, the present disclosure provides a propulsion system for implementing flight operations of an aerial vehicle. Specifically, the propulsion system may include: A motor; and an ESC as described in any of the forgoing embodiments.

The ESC is electrically connected to the motor to control the operation of the motor.

Specifically, the ESC may control the rotation speed of the motor according to a received control signal to adjust the flight operation of the aerial vehicle. The motor may be any type of motors used in multi-rotor UAVs. There are no specific restrictions of the motor type. Structures other than the configuration of the ESC interface may adopt similar configuration of existing multi-rotor UAVs.

The structure, working principle and the effect of the ESC in the embodiment may be the same as those of the ESCs described in foregoing embodiments. For details, refer to the forgoing embodiments, and no further details are provided again.

According to certain embodiments, the propulsion system may directly assign an address to the ESC by a processor of the ESC according to a voltage collected at the first communication interface, thereby simplifying the assembly process, saving assembly time and avoiding security risks caused by incorrect installation. The address assignment method may be the same during maintenance of the multi-rotor UAV ESC, that is, when the ESC is installed during maintenance, the ESC may be installed in any ESC installation position on the frame without considering the correspondence between the location and the ESC communication address. This approach may significantly improve the efficiency of ESC maintenance, saves costs, and avoid the safety hazard caused by an incorrect installation position of the ESC.

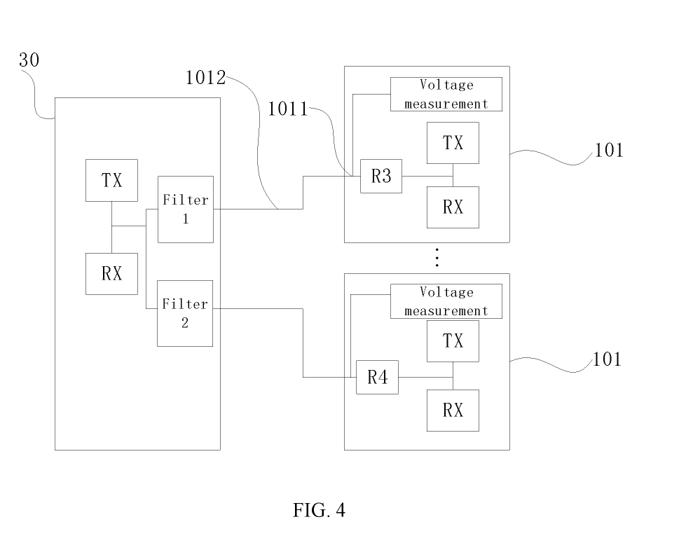

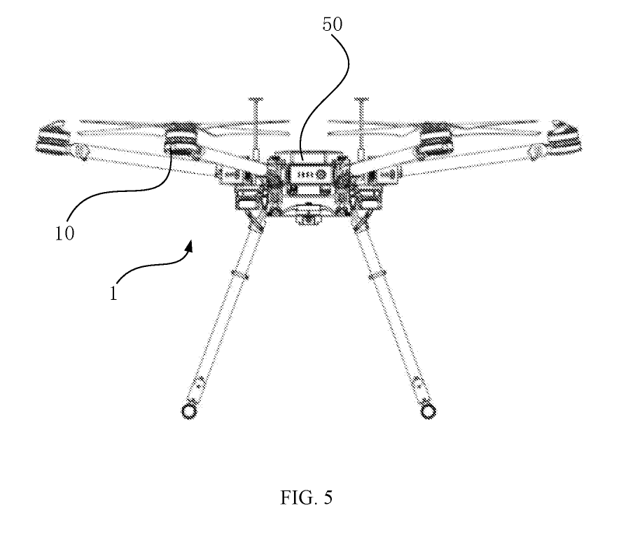

FIG. 4 is a diagram illustrating an ESC control system connected to a controller according to certain embodiments of the present disclosure. FIG. 5 is a schematic structural diagram of a multi-rotor UAV according to certain embodiments of the present disclosure. With reference to FIG. 5, the present disclosure provides a multi-rotor UAV 1. The multi-rotor UAV 1 includes a frame 50 and a plurality of propulsion systems 10 as described in foregoing embodiments. The propulsion systems 10 are configured on the frame 50. As shown in FIG. 4, the multi-rotor UAV 1 also includes a controller 30 communicatively connected to the first communication interface 1011 of the plurality of ESCs 101. The controller 30 may send a throttle signal to the ESC 101. The ESC 101 may control the rotation speed of the motor according to the throttle signal to provide flight power for the multi-rotor UAV 1.

It should be noted that the frame 50 in certain embodiments may be any type of frame used in multi-rotor UAVs. Further, the specific shape and structure of the controller 30 are not limited in the embodiments. Further, the controller 30 may be configured as a flight controller, and the flight controller may have the same features as existing flight controllers except for the differences described below.

In certain embodiments, the structure, the working principle and the effect of the propulsion system 10 may be the same as the propulsion system described in any of the forgoing embodiments. For details, refer to the forgoing embodiments, and no further details are provided again.

The multi-rotor UAV 1 provided by the present disclosure may directly assign an address to the ESC 101 according to a voltage collected at the first communication interface 1011 by a processor of the propulsion system 10, thereby simplifying the assembly process, saving assembly time and avoiding security risks caused by incorrect installation of the ESC 101. The address assignment method may be the same during maintenance of the ESCs of a multi-rotor UAV, that is, when an ESC 101 is installed during maintenance, the ESC 101 may be installed in any ESC installation position on the frame 50 without considering the correspondence between the location and the ESC communication address. This approach may significantly improve the efficiency of ESC maintenance, saves costs, and avoid the safety hazard caused by an incorrect installation position of the ESC.

Based on the above embodiments, with continued reference to FIG. 4, the ESC 101 on the multi-rotor UAV 1 is used for communication with a controller 30 in order to ensure the reliability of communication connection between the ESC on the multi-rotor UAV 1 and the controller 30, a second communication interface is configured on the controller 30. The second communication interface is connected in series with a voltage adjustment element. The second communication interface connects with the first communication interface 1011 through voltage adjustment element.

The first communication interface 1011 may be configured on the ESC 101. The ESC 101 and the controller 30 may be communicably connected through the first communication interface 1011 and the second communication interface, thereby effectively ensuring stable and reliable data interaction. The present disclosure does not limit the specific shape, structure and the installation position of the voltage adjusting component. These parameters may be determined according to specific design requirements. Further, the voltage adjusting component may be configured as a resistor-capacitor (RC) filter, and may be integrated inside the controller 30, which effectively simplifies the design and layout of the circuit.

The multi-rotor UAV 1 may be provided with a plurality of motors, and each motor may be connected with an ESC 101. In order to insure the stability and reliability of the data interaction between the controller 30 and each ESC 101, a plurality of second communication interfaces may be configured. The plurality of second communication interfaces may be communicatively connected to the first communication interfaces 1011 of the plurality of ESCs 101 respectively. The RC filters of the plurality of second communication interfaces may be RC filters with different cut-off frequencies

In certain embodiments, in order to facilitate the operation of assigning a unique address to each ESC 101 of the multi-rotor UAV 1, referring specifically to FIG. 4, the multi-rotor UAV 1 may include a controller 30 and a plurality of ESCs 101. The controller 30 may be communicatively connected to each ESC 101 through a communication link. The controller 30 may be connected to RC filters. The RC filters may be integrated in the controller 30. The RC filter on a different communication link may have a different cut-off frequency. Therefore, for each communication link, the amplitude of the voltage on the link processed by the RC filter is different, and thus the detected voltage information at the first communication interface 1011 on each 101 is different. As a result, the address information corresponding to the voltage information may be determined by using the preset mapping relationship between the voltage information and the address information, and the determined address information may be used to assign a unique address to the ESC 101. The operation effectively avoids the safety hazard of the controller 30 due to the installation position error of the ESC 101 and improves the safety and reliability of the multi-rotor UAV 1.

Based on the above embodiments, with reference to FIG. 4, when the controller 30 performs data interaction with the ESC 101, in order to further simplify the complexity of the circuit, a single communication line 1012 may be configured between the first communication interface 1011 and the second communication interface to implement a single-line communication between the controller 30 and the ESC 101.

For the controller 30, data may be transmitted to the ESC 101 through the configured single communication line 1012. The controller 30 may also receive data from the ESC through the signal communication line 1012. Similarly, for the ESC 101, the single communication line 1012 may be configured to receive data sent by the controller 30, and can also send data to the controller 30. Specifically, for the ESC 101, the first communication interface 1011 is configured to include a first TX data interface and a first RX data interface. The first TX data interface is for transmitting data, and the first RX data interface is for receiving data. In order to implement simultaneous data transmission and reception through the single communication line 1012, one end of the single communication line 1012 may be electrically connected to the first RX data interface and the first TX data. Similarly, for the controller 30, the second communication interface is configured to include a second TX data interface and a second RX data interface, wherein the second TX data interface is for transmitting data and the second RX data interface is for receiving data. In order to implement simultaneous data transmission and reception through the single communication line 1012, the other end of the single communication line 1012 may be electrically connected to the second RX data interface and the second TX data interface.

It should be noted that during data interaction, when the controller 30 transmits data information to the ESC 101, one end of the single communication line 1012 may be connected to the second TX data interface, and the other end may be connected to the first RX data interface. When the controller 30 receives data sent by the ESC 101, one end of the single communication line 1012 may be connected to the second RX data interface, and the other end may be connected to the first TX data interface. This configuration effectively implements data interaction between the controller 30 and the ESC 101.

In certain embodiments, the multi-rotor UAV 1 may implement data interaction between the controller 30 and each of the ESCs 101 through a single communication line 1012. It does not only ensure assigning a unique address to each ESC 101, but also simplifies the complexity of the circuit, eliminates the need for additional hardware, saving costs while effectively improving the safety and reliability of the multi-rotor UAV 1, which benefits the utility and market adoption of the product.

The technical solutions and technical features in the foregoing various embodiments of the present disclosure may be separate or combined when there is no confliction. Equivalent embodiments are within the scope of the present disclosure as long as they do not exceed the knowledge scope of those skilled in the art.

In the several embodiments provided by the present disclosure, it should be understood that the disclosed system, apparatus, and method may be implemented in other manners. For example, the device embodiments described above are merely illustrative. For example, the division of the units is only a logical function division. In actual implementation, there may be another division manner, for example, multiple units or components may be combined or integrated into another system. Some features can be omitted or not executed. In addition, the coupling or direct coupling or communication connection shown or discussed may be an indirect coupling or communication connection through some interface, device or unit, and may be electrical, mechanical or otherwise.

The units described as separate components may or may not be physically separated, and the components displayed as units may or may not be physical units, that is. They may be located in one location or may be distributed to multiple network units. Some or all of the units may be selected according to actual needs to achieve the purpose of the solution of the embodiment.

Further, each functional unit in each embodiment of the present disclosure may be integrated into one processing unit, or each unit may exist physically separately, or two or more units may be integrated into one unit. The above integrated unit may be implemented in the form of hardware or in the form of a software functional unit.

The integrated unit, if implemented in the form of a software functional unit and sold or used as a standalone product, may be stored in a computer readable storage medium. Based on such understanding, the technical solution of the present disclosure, or all or part of the technical solution, may be embodied in the form of a software product stored in a storage medium, including several instructions for instructing a computer processor 101 (processor) to perform all or part of the steps of the methods of the various embodiments of the present disclosure. The storage medium may include: a U disk, a mobile hard disk, a read-only memory (ROM), a random-access memory (RAM), a magnetic disk, or an optical medium that can store program codes.

The foregoing embodiments are not intended to limit the scope of the present disclosure. Equivalent structures or equivalent process transformations made based on the description and drawings of the present disclosure directly or indirectly applied to other related technologies are all included in the scope of the present disclosure.

It should be noted that the above embodiments are merely illustrative of the technical solutions of the present disclosure, and are not intended to be limiting. Although the present disclosure has been described in detail with reference to the foregoing embodiments, those skilled in the art will understand that the technical solutions described in the foregoing embodiments may be modified, or some or all of the technical features may be equivalently replaced; and the modifications or substitutions do not deviate from the scope of technical solutions of the present disclosure.

What is claimed is:

1. A multi-rotor unmanned aerial vehicle (UAV), comprising:
a frame;
a plurality of propulsion systems configured on the frame, each propulsion system including a motor and an electronic speed control (ESC) device, wherein the ESC device of each propulsion system includes:
a first communication interface; and
a processor configured to acquire voltage information at the first communication interface and determine address information of the ESC according to the voltage information; and
a controller connected to the first communication interface of the ESC device of each propulsion system, and configured to send a throttle signal to the ESC device of each propulsion system.

2. The UAV according to claim 1, wherein:
the UAV includes a plurality of voltage-adjustment components;
the controller comprises a plurality of second communication interfaces; and
for each second communication interface:
the second communication interface has a one-to-one correspondence with one of the plurality of propulsion systems;
the second communication interface has a one-to-one correspondence with one of the plurality of voltage-adjustment components;
the second communication interface is connected in series with the corresponding voltage-adjustment component; and
the second communication interface is connected to the first communication interface of the ESC device of the corresponding propulsion system through the corresponding voltage-adjustment component.

3. The UAV according to claim 2, wherein the plurality of voltage-adjustment components are resistor-capacitor (RC) filters.

4. The UAV according to claim 2, wherein each of the plurality of voltage-adjustment components has a cut-off frequency different from any other voltage-adjustment component of the plurality of voltage-adjustment components.

5. The UAV according to claim 2, wherein the plurality of voltage-adjustment components are integrated in the controller.

6. The UAV according to claim 2, wherein, for each second communication interface:
the second communication interface is connected to the first communication interface of the ESC device of the corresponding propulsion system with a corresponding communication line, the corresponding communication line configured to perform a single-channel communication between the second communication interface and the first communication interface of the ESC device of the corresponding propulsion system.

7. The UAV according to claim 6, wherein, for each propulsion system:
the first communication interface of the ESC device of the propulsion system includes a first TX data interface and a first RX data interface; and
a first end of the corresponding communication line is connected to the first TX data interface and the first RX data interface.

8. The UAV according to claim 7, wherein, for each second communication interface:
the second communication interface includes a second TX data interface and a second RX data interface; and
a second end of the corresponding communication line is connected to the second TX data interface and the second RX data interface.

9. The UAV according to claim 7, wherein the controller is a flight controller.

10. The UAV according to claim 6, wherein for each second communication interface:
the single-channel communication is a frequency-division multiplexing communication.

11. The UAV according to claim 6, wherein for each second communication interface:
the single-channel communication is a time-division multiplexing communication.

12. The UAV according to claim 1, wherein:
the UAV further includes a plurality of first voltage-dividing components, each first voltage-dividing component having a one-to-one correspondence with one of the plurality of the propulsion systems; and
for each propulsion system, the first communication interface of the ESC device is coupled with the corresponding first voltage-dividing component through a series connection.

13. The UAV according to claim 12, wherein:
the UAV further includes a plurality of second voltage-dividing components, each second voltage-dividing component having a one-to-one correspondence with one of the plurality of second communication interfaces; and
each second communication interface is coupled with the corresponding second voltage-dividing component through a series connection.

14. The UAV according to claim 13, wherein the plurality of first voltage-dividing components are resistors having a same first resistance value.

15. The UAV according to claim 14, wherein each second voltage-dividing component is a resistor having a resistance value different from the resistance value of any other second voltage-dividing component in the plurality of second voltage-dividing components.

16. The UAV according to claim 1, wherein for each propulsion system, the voltage information is a voltage value measured at the first communication interface of the ESC device.

17. The UAV according to claim 16, wherein for each propulsion system, the processor of the ESC device is configured to assign a unique address to the ESC device according to the voltage value measured at the first communication interface of the ESC device.
